(19) United States
(12) Patent Application Publication
(10) Pub. No.: US 2025/0297926 A1
(43) Pub. Date: Sep. 25, 2025

(54) FLUID SAMPLING DEVICE

(71) Applicant: Gill, LLC, Fort Collins, CO (US)

(72) Inventors: Sarvjit Gill, Fort Collins, CO (US); Keith Dirks, Fort Collins, CO (US)

(21) Appl. No.: 18/655,581

(22) Filed: May 6, 2024

Related U.S. Application Data
(60) Provisional application No. 63/568,888, filed on Mar. 22, 2024.

(51) Int. Cl. G01N 1/10; B65D 47/06

(52) U.S. Cl. CPC G01N 1/10; B65D 47/06

(57) ABSTRACT

A support structure for a liquid sampling device has an upper cavity and a neck within the upper cavity. The neck has a first end and a second end, and a passage that extends from the first end to the second end, and opens into a bottom opening of the support structure. The bottom opening is configured to attach to a liquid sample container. The support structure may also include a gas exhaust path and a second neck configured to attach to a gas-exhaust line. The support structure may also be configured to retain an adapter configured to engage a secure cap on the liquid sample container.

### CROSS-REFERENCE TO RELATED APPLICATIONS

This application claims priority to U.S. Provisional Application No. 63/568,888, entitled Fluid Sampling Device, filed on Mar. 22, 2024.

### BACKGROUND

In certain applications, it is desirable to collect a sample of a fluid from a vessel. As one example, the fluid could be water, such as water recovered during a fracking/crude oil or natural gas collection operation. A sample of the water could be taken by an operation manually opening a valve and allowing the sample to flow into a container but such an operation is inefficient and may expose the operator to harmful gases or liquid contaminants.

Incorporated herein by reference is U.S. Patent Application No. PCT Patent No. PCT/US23/17338, filed on Apr. 3, 2023 and entitled LOCKING SAMPLE CAP.

### SUMMARY

Disclosed herein is a liquid sampling device having a support structure. The liquid sampling device can be connected to a source of liquid to be sampled and to a liquid sampling container that holds the liquid sample. The liquid sampling device includes a connector to connect to the source of the liquid to be sampled, a fluid line having a first end attached to the connector and a second end connected to the support structure.

The support structure has a first end juxtaposed the second end of the fluid line, a second end, a cavity, and a neck within the cavity. The neck has a first end and a second end, a passage in the neck that extends from the first end to the second end, and the passage opens into a bottom opening of the support structure. The bottom opening is configured to attach to the liquid sample container. The support structure may also have (1) a second neck to exhaust gas from the liquid as it enters the liquid sample container, and (2) an adapter configured to engage a security cap on the liquid sample container.

When an operator desires to take a liquid sample, liquid from the liquid source is released into the fluid line and flows into the neck of the support structure and through the bottom opening and into the liquid sample container without being physically handled. The support structure may include a passage (or gas reservoir) in the cavity for gas from the liquid inside of the liquid sample container to be released through the second neck, which may be attached to a gas exhaust line.

### BRIEF DESCRIPTION OF THE DRAWINGS

FIG. 1 is a front, perspective view of a fluid collection adapter according to this disclosure.

FIG. 2 is a front, perspective view of a fluid sample container according to this disclosure.

FIG. 3 is a front, perspective, exploded cross-sectional view taken through line A-A of the fluid collection adapter of FIG. 1.

FIG. 4 is a front, perspective view of the support structure of FIG. 1.

FIG. 5 is a front, perspective view of the support structure of FIG. 4.

FIG. 6 is a top view of the support structure of FIG. 4.

FIG. 7 is a cross-sectional side view of the support structure of FIG. 6 taken through line B-B.

FIG. 8 is a side view of the support structure of FIG. 4.

FIG. 9 is a cross-sectional side view of the support structure of FIG. 8 taken through line C-C.

FIG. 10 is a bottom view of the support structure of FIGS. 6-9.

FIG. 11 is a top view of the support structure of FIG. 4 without the adapter.

FIG. 12 is a cross-sectional side view of the support structure of FIG. 11 taken through line D-D.

FIG. 13 is a side view of the support structure of FIG. 11.

FIG. 14 is a cross-sectional side view of the support structure of FIG. 13 taken through line E-E.

FIG. 15 is a bottom view of the support structure of FIGS. 11-14.

FIG. 16 is a top view of an adapter according to this disclosure.

FIG. 17 is a side perspective view of the adapter of FIG. 16.

FIG. 18 is a side view of the adapter of FIG. 16.

FIG. 19 is an alternate side view of the adapter of FIG. 16 with the adapter rotated 90° from the side view shown in FIG. 18.

FIG. 20 is a bottom view of the adapter of FIG. 16.

FIG. 21 is a cross-sectional side view of the adapter of FIG. 18 taken through line F-F.

FIG. 22 is a front, perspective view of a fluid collection adapter according to this disclosure.

FIG. 23 is a front, perspective view of a fluid sample container according to this disclosure.

FIG. 24 is a front, perspective, exploded cross-sectional view of the fluid collection adapter of FIG. 23 taken though line G-G.

FIG. 25 is a front, perspective view of the support structure of FIG. 23.

FIG. 26 is a front, perspective view of the support structure of FIG. 25.

FIG. 27 is a top view of the support structure of FIG. 22.

FIG. 28 is a cross-sectional, side view of the support structure of FIG. 27 taken through line ff-ff.

FIG. 29 is a side view of the support structure use of FIG. 27.

FIG. 30 is a cross-sectional side view of the support structure of FIG. 29 taken through line I-I.

FIG. 31 is a bottom view of the support structure of FIG. 27.

FIG. 32 shows an alternate liquid fluid collection device according to this disclosure that includes a grounding structure.

### DEVICE

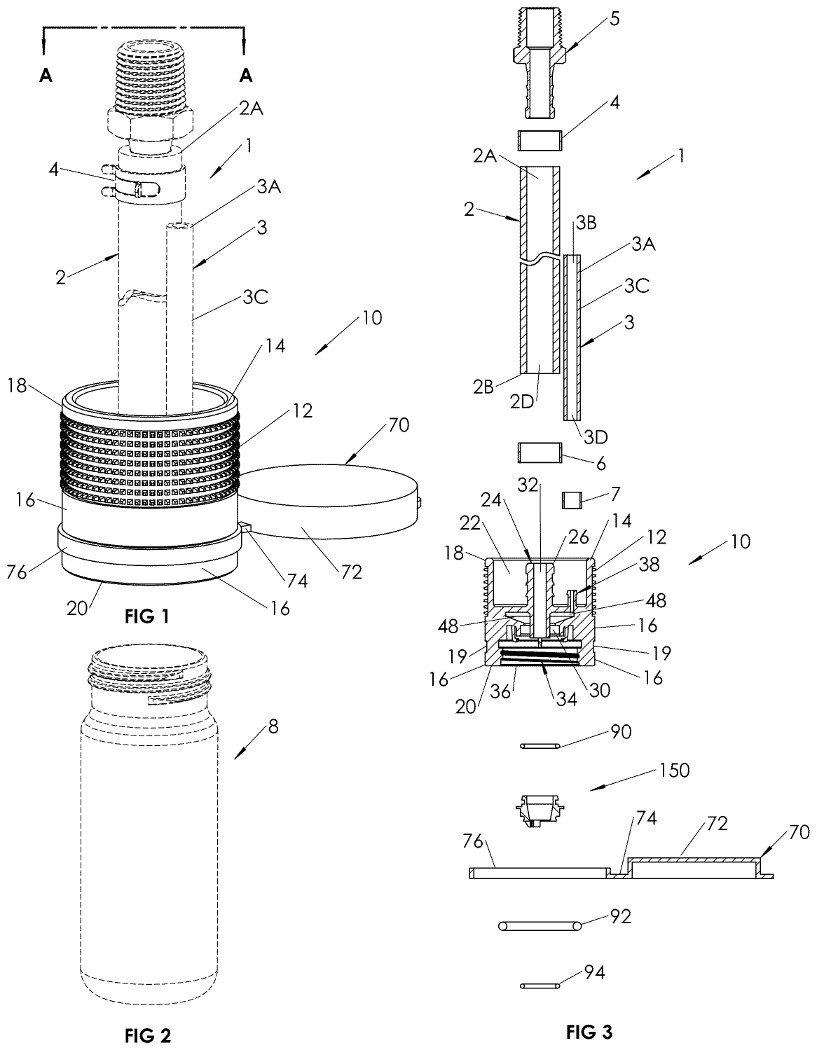

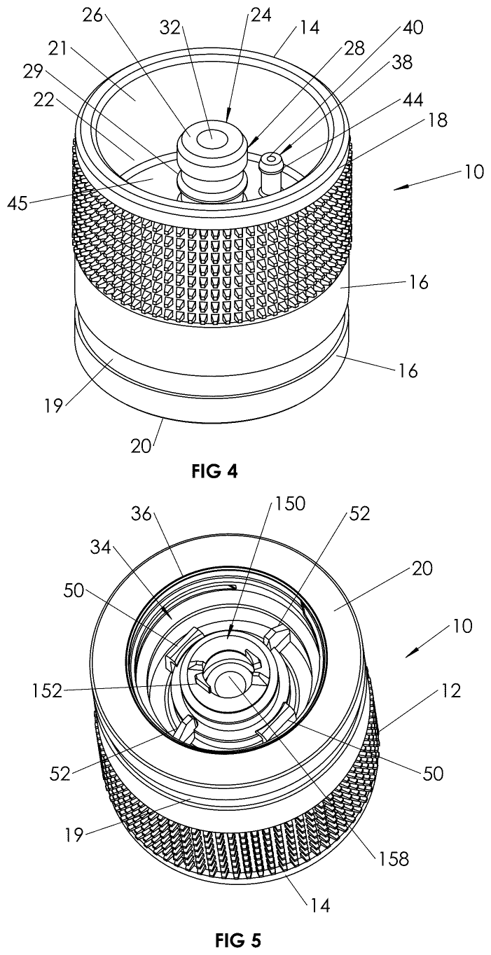

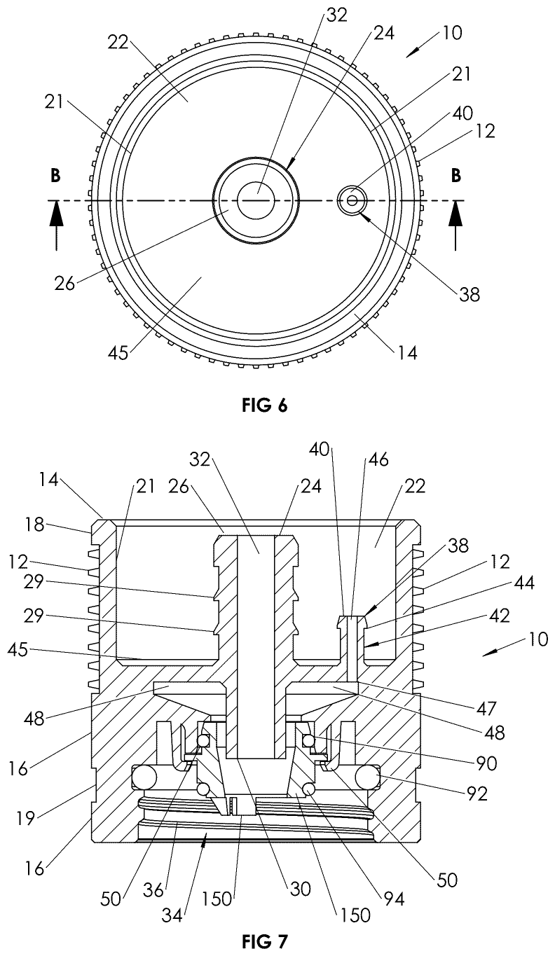

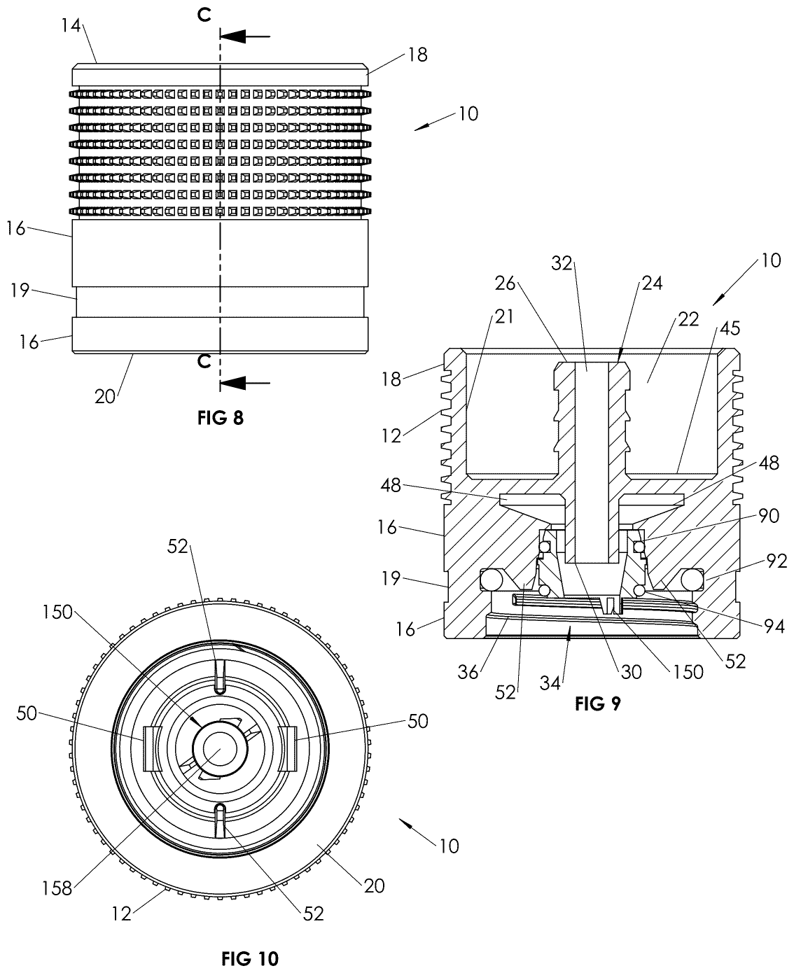

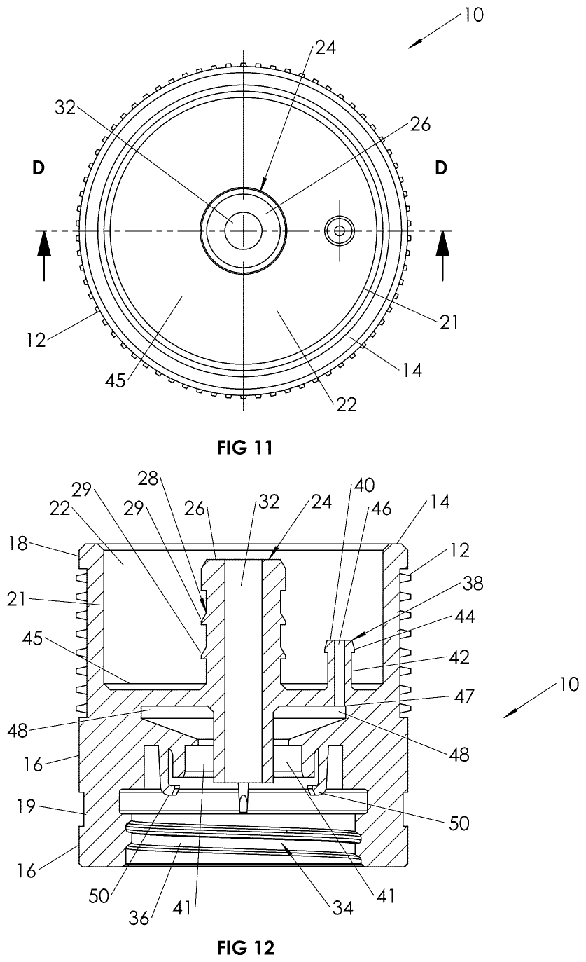

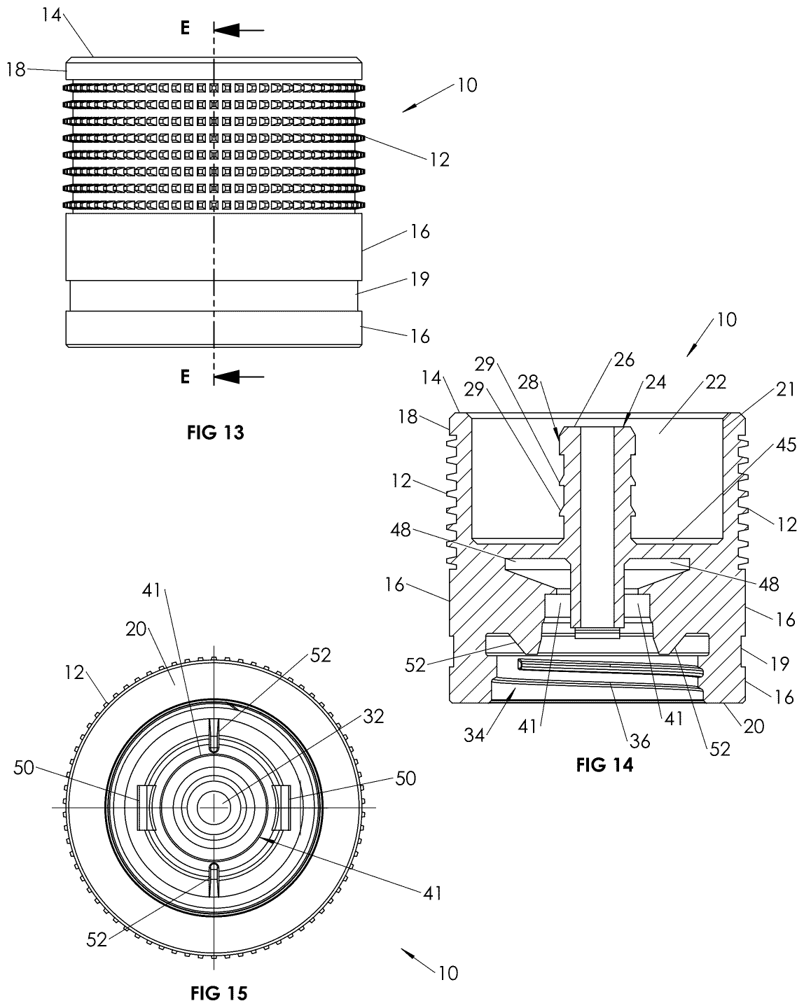

Turning now to the FIGS., wherein the purpose is to describe embodiments of this disclosure and not to limit the scope of the claims, a fluid collection device 1 is shown in FIGS. 1-2. Fluid collection device 1 has a fluid tube 2, which can be any type of flexible or rigid tube made of any suitable material, such as plastic, but is preferably a flexible tube of any suitable width or length. Fluid tube 2 has a first end 2A, a second end 2B, a wall 2C, and a lumen 2D.

Fluid collection device 1 further comprises a gas exhaust tube 3, which can be any type of flexible or rigid tube made of any suitable material, such as plastic. Tube 3 can be of any suitable width or length. Gas exhaust tube has a first end 3A, a second end 3B, a wall 3C, and a lumen 3D.

A collar 4 may be used to apply pressure to wall 2C and pressure fit first end 2A onto a stem of connector 5. Connector 5 as shown has a threaded end for connecting to a fluid container (or source), which is not shown. Any suitable connector structure for connecting to a fluid container may be used.

A snap ring 6 may be used to help secure second end 2B of fluid tube 2 to first neck 24 of support structure 10. A snap ring 7 may be used to secure second end 3B to second neck 38 of support structure 10.

### Support Structure

Support structure 10 has an outer annular surface with a gnarled or bumpy surface 12 that is relatively easy for a user to quip. Above surface 12 is a smooth, annular surface 18. Below surface 12 is a smooth, annular surface 16 having an annular recess 19. Support structure 10 has an upper rim 14 and a bottom rim 20.

Support structure 10 has an upper, annular inner wall 21 and upper cavity 22. First neck 24 has a first (or upper) end 26, and an outer surface 28 that includes one or more ridges or barbs 29. When second end 2B of fluid line 2 is positioned over first neck 24 the ridges or barbs 29 help to secure fluid line 2 to first neck 24. First neck 24 also has a second end 30 (seen, for example, in FIG. 7) and a fluid passage 32 extending from first end 26 to second end 30 and opens to bottom opening 34.

Bottom opening 34 is, in one embodiment, configured to receive an adapter 150 and to connect to a fluid container 8 (shown, for example, in FIG. 1). Bottom opening 34 includes threads 36 that mate with threads on fluid container 8 to connect container 8 to bottom opening 34. Any suitable type of attachment structure, however, may be used. Further, as used herein the term “threads” refers to one or more threads. As shown in the Figures, threads 36 are a single, helical thread. O-ring 92 can be positioned in an annular groove of bottom opening 34, wherein O-ring 92 is configured to seal between bottom opening 34 and liquid sample container 8 when liquid sample container 8 is positioned in bottom opening 34.

Second neck 38 is also positioned in upper cavity 22 and has an upper, or first, end 40, an outer surface 42, and a barb or rib 44. When second end 3B of gas exhaust tube 3 is positioned on second neck 38, barb or rib 44 helps to secure gas exhaust tube to second neck 38. The upper part of support structure 10 also has a base (or bottom surface) 45 in cavity 22. Second neck 38 also has a second end 47 and a passage 46 that extends from first end 40 to second end 47 and is in communication with exhaust gas reservoir 48.

As shown, for example, in FIG. 12 a retention cavity 41 is in lower opening 34, wherein retention cavity 41 is configured to retain adapter 150 as explained in more detail herein. Two clips 50 are formed on either side of retention cavity 41 and are configured to hold adapter 150 in place in retention cavity 41. As can be seen, for example, in FIGS. 14-15, there are angled surfaces 52 in bottom opening 34, which are configured to be received in openings 160 in adapter 150 to properly locate adapter 150 in retention cavity 49 and to prevent adapter 150 from rotating.

FIG. 15 is a bottom view of support structure 10 without adapter 150. Clips 50 and anti-rotation surfaces 52 can be seen in bottom opening 34 and retention cavity 41.

### Adapter

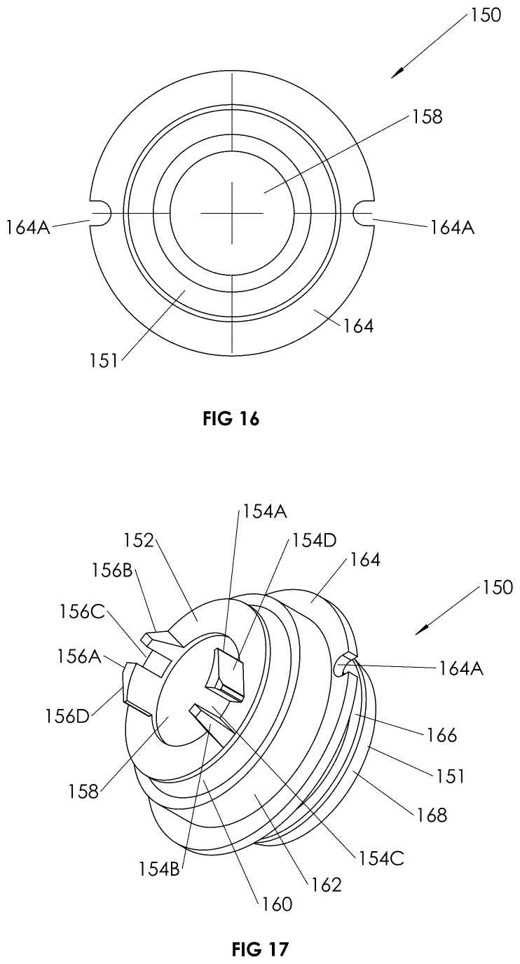

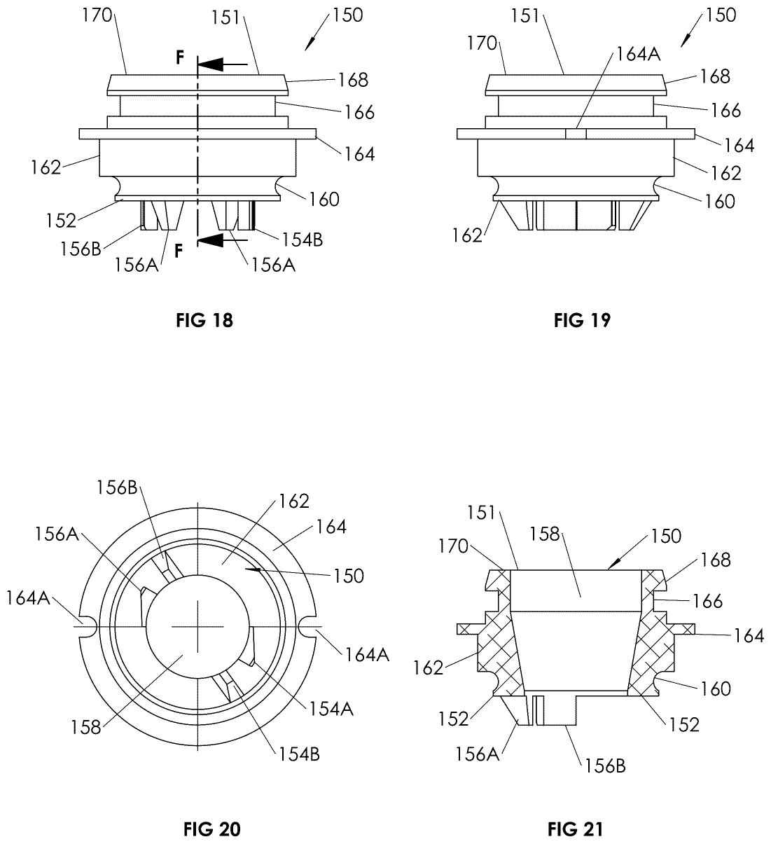

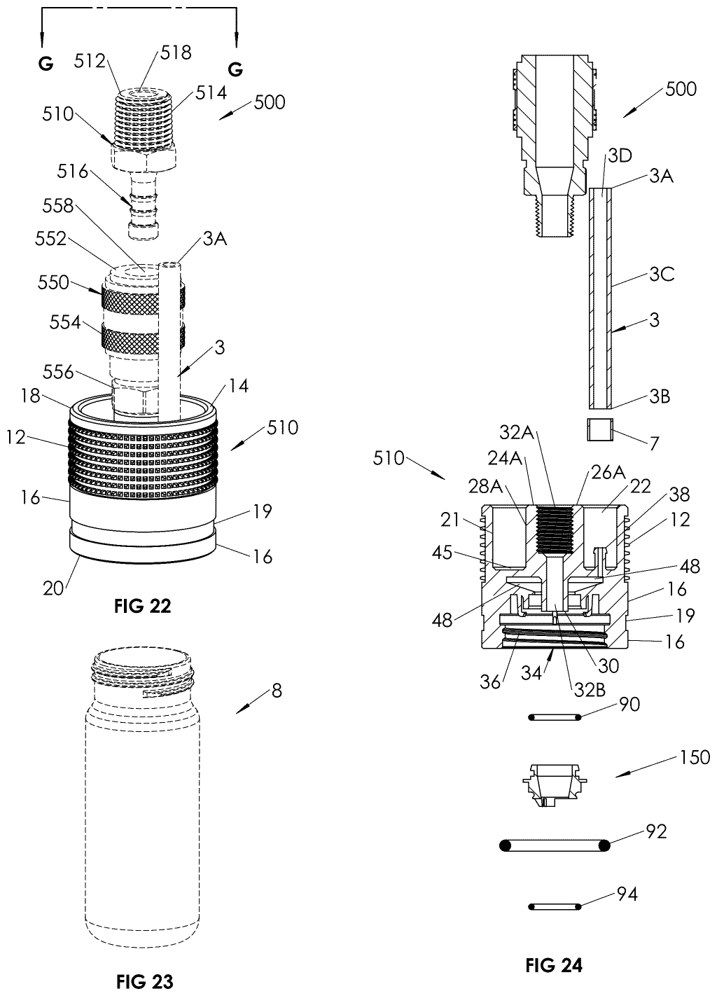

FIGS. 16-21 show adapter 150, which is also shown attached to support structure 10 in other Figures. Adapter 150 has a bottom surface or second end 152 and a first end 151. Projections 154A and 154B define a pocket 154C between them. Projections 156A and 156B define a pocket 156C between them. An opening 158 extends through adapter 150 from first end 151 to second end 152. Projections 154A, 154B, 156A, 156B, and pockets 154C and 156C are configured to interact with cap projections on a secure cap (or simply “cap”) that may be used on fluid container 8. Such a cap is disclosed in PCT Patent Application No. PCT/US23/17338.

Turning again to FIGS. 16-21, adapter 150 includes a first groove 166 that is configured to receive first O-ring 90, which seals between the adapter 150 and a wall of the bottom opening 34 when the adapter 150 is positioned in the bottom opening 34. An upper surface 168 leads to upper, or first, end 151. Adapter 150 also includes a lower, or second, O-ring groove 160 to retain O-ring 94, which seals between the adapter 150 and the top of the liquid sample container 8 when liquid sample container is positioned in bottom opening 34. Adapter 150 further includes a separation surface 162, a flange 164 with a surface 164A on which clips (or retainers) 50 are positioned when adapter 150 is retained in support structure 10, and openings 164B on the outer edge of flange 165 that are configured to receive anti-rotation surfaces 52 when adapter 150 is retained in support structure 10.

### Support Structure with Quick Connect Fitting

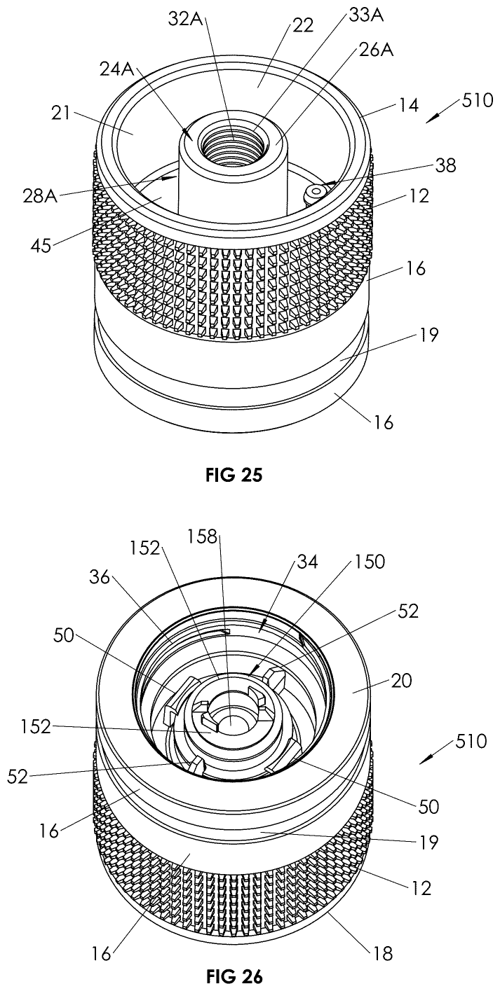

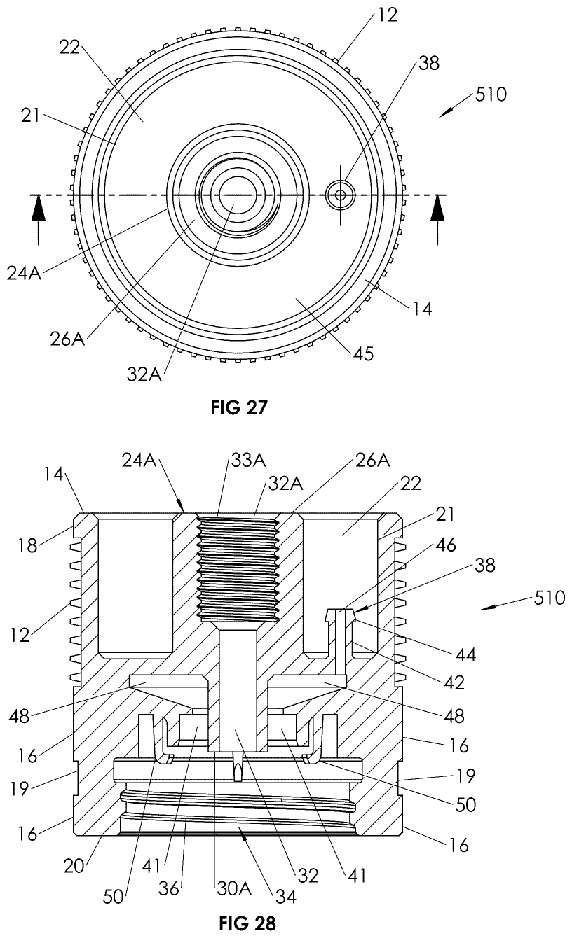

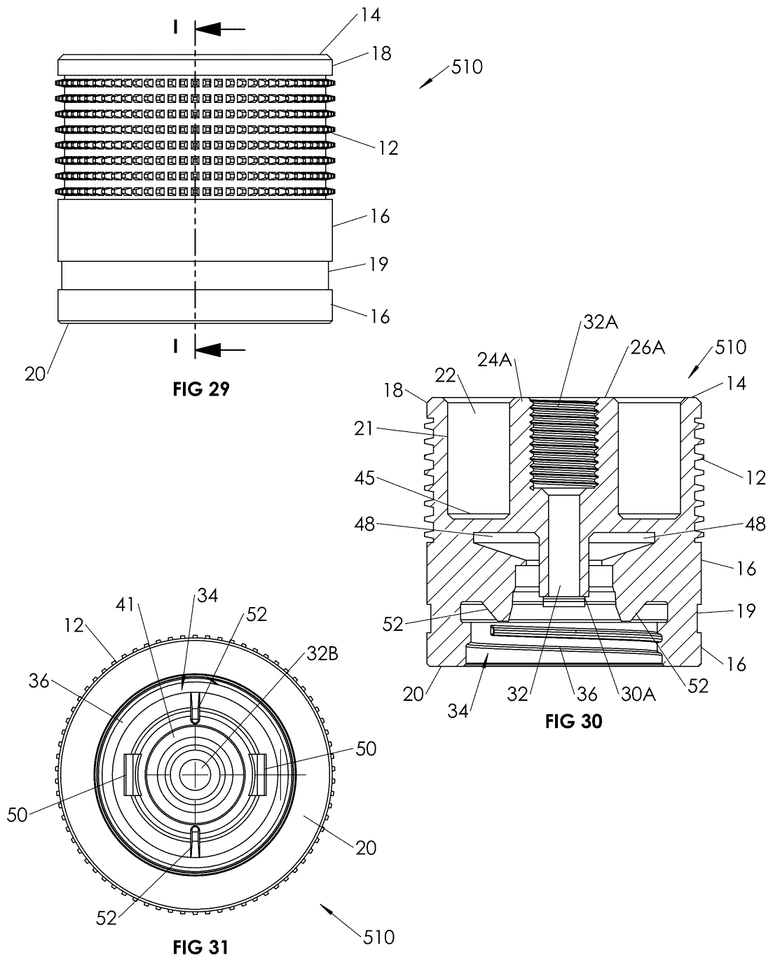

Turning to FIGS. 23-31 an alternative liquid sampling device 500 is shown that is in all respects the same as device 1 except for the support structure 510 and the quick-connect (or quick-release) fitting 510 to which it is designed to connect. Quick-connect attachment 550 of support structure 510 is designed to receive and connect to a quick-release connector 510 having a connector stem 516 that is configured to be received in opening 558 of attachment 550. Connector 510 includes a top surface 512, a threaded annular outer surface 514 configured to connect to a fluid reservoir (not shown) and a passage 518 extending through connector 510.

Attachment 550 includes a rough or knurled outer ridge 554 for easy gripping, a top 552, an opening (or passage) 558 that extends through attachment 550, and a bottom connector 556 that tightens onto neck 24A of support structure 510.

Support structure 510 is the same as support structure 10 except that it has a neck 24A instead of neck 24. Neck 24A has a passage that extends from top 26A, wherein there is passage 32A, through second end 30A, wherein there is passage 32B. Passage 32A and 32B are connected and extend through bottom opening 34, so fluid that enters top 26A of neck 24A passes through passages 32A and 32B, through bottom opening 34 and into sample container 8. If adapter 150 is used the liquid would also pass through opening 158 of adapter 150.

The secure cap (not shown) has upwardly-extending projections and is in a closed position when connected to the bottom opening 34 of support structure 10. As the fluid container 8 is threaded into opening 34 container 8 moves upwards until the projections on the secure cap slide past the angled outer surface of projections 154A and 156A and are positioned, respectively, in pockets 154C and 156C. Once in the pockets the projections on the secure cap cannot move and as the fluid container 8 continues to move upwards the bottom of the secure cap rotates relative the stationary adapter 150 and support structure 10 or 510 and the secure cap moves to an open position. In this position liquid entering the neck 24 or 24A passes through the passage 28 or 32A, 32B, through opening 158 in adapter 150, through bottom opening 34, through an opening in the secure cap and into fluid container 8.

When fluid container 8 is removed from bottom opening 34 it moves downward as it is rotated. The projections from the secure cap are still retained, respectively, in pockets 154C and 156C so the top of the secure cap remains stationary. The secure cap rotates to a closed and locked position as liquid container 8 rotates. As liquid container 8 continues to lower as it is unthreaded from threads 36 its projections move out of pockets 154C and 156C and the secure cap remains in its closed and locked position.

Once the secure cap is unscrewed from the support structure 10 or 510 liquid container 8 with the secure cap on it, and possibly having a security top closure placed over the secure cap is then sent to a laboratory or similar facility.

### Optional Ground

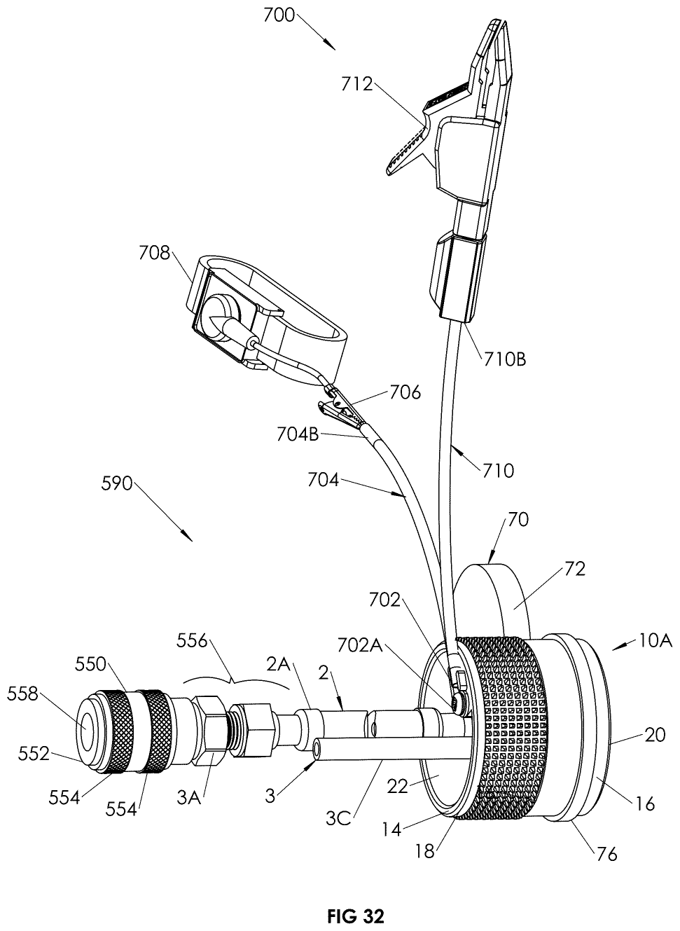

Turning to FIG. 32 an alternative liquid sampling device 590 is shown that is in all respects the same as device 1 except that it includes a grounding structure 700, and an alternate liquid fluid line 2 with a quick-connect connector (or attachment) 550 attached to the top (or first) end of the liquid fluid line 2. Quick-connect connector 550 is configured to connect to quick-connect (or quick-release) fitting 510, as previously described.

Attachment 550 includes a rough or knurled outer ridge 554 for easy gripping, a top 552, an opening (or passage) 558 that extends through attachment 550, and a bottom connector 556 that attaches to the first end 2A of liquid fluid line 2.

Support structure 10A is the same as support structure 10 except that it has ground system 700, which can be any suitable structure for grounding a user of liquid sampling device 590 and/or support structure 510. Support structure 510 may or may not include an adapter 150.

Grounding structure 700 is configured to prevent static electricity shock to a user (or operator) by grounding static electricity from the user (not shown) through a post on support structure 510 to a metallic ground at any suitable location.

Grounding structure 700 comprises a metal post 702 having a connector 702A, which as shown is a screw but can be any suitable connector. A first wire 704 has a lead (not shown) connected to post 702 by connector 702A and a second end 704B that is attached via a clip 706 to a wrist band 708 that is worn by an operator.

A second wire 710 has a lead (not shown) connected to post 702 (and to the lead of the first wire) by connector 702A and a second end 710B that is attached to a grounding structure, which as shown is a clip 712 that can connect to any suitable metal ground.

In use, an operator would ground the support structure 10A or liquid sampling device 590 by preferably first securing the lead of wire 704 and wire 710 to post 702. The securing clip 712 to a metallic ground and then placing the wrist band 708 on his/her wrist.

Alternatively, a ground for an operator could be done in any suitable manner.

Some non-limiting examples of this disclosure follow:

Example 1: A liquid sampling device comprising:
(a) a first connector for connecting to a source of liquid to be sampled;
(b) a fluid line having an outer wall, a lumen inside of the outer wall, a first end attached to the connector and a second end; and
(c) a support structure having a first end, a second end, a cavity, a neck within the cavity, wherein the neck has a first end and a second end, a passage in the neck that extends from the first end to the second end, and that opens into a bottom opening of the support, and wherein the bottom opening is configured to attach to a liquid sample container, and wherein the second end of the fluid line is connected to the first end of the neck, and the lumen is in communication with the passage.

Example 2: The liquid sampling device of example 1, wherein the bottom opening comprises threads configured to mate with threads on the liquid sample container.

Example 3: The liquid sampling device of example 1 or example 2, wherein the support structure that has a cylindrical outer surface.

Example 4: The liquid sampling device of example 3, wherein the cylindrical outer surface comprises a grip section with dimples.

Example 5: The liquid sampling device of example 4, wherein the support structure has a height and the grip section extends along 50% or more of the height.

Example 6: The liquid sampling device of any one of examples 3-5, wherein the outer surface comprises an annular groove configured to receive an O-ring of a sealing cap, and wherein the sealing cap has a first position in which it is attached to and seals the bottom opening of the support structure and a second position in which it is removed from the bottom opening of the support structure.

Example 7: The liquid sampling device of example 6 that further includes the sealing cap.

Example 8: The liquid sampling device of any one of examples 1-7 that further includes a gas exhaust line that includes a first end, a second end, an outer wall, and an exhaust inside of the outer wall.

Example 9: The liquid sampling device of example 8, wherein the cavity of the support structure further includes a gas exhaust pathway leading to a second passage in a second neck.

Example 10: The liquid sampling device of example 8, wherein the second neck has a first end and a second end and the second passage extends from the first end to the second end and forms part of the gas exhaust pathway.

Example 11: The liquid sampling device of example 9, wherein the second end of the gas exhaust line is attached to the first end of the second neck.

Example 12: The liquid sampling device of example 11, wherein the second neck has one or more outer rings configured to fit inside of the second pathway and retain the gas exhaust line on the second neck.

Example 13: The liquid sampling device of example 7, wherein the first neck has one or more outer rings configured to be received inside of the limen and retain the fluid line on the first neck.

Example 14: The liquid sampling device of example 7 or example 13 that further comprises a first snap ring positioned over the second end of the fluid line at the first neck, wherein the first snap ring is configured to compress the fluid line onto the first neck.

Example 15: The liquid sampling device of example 10 that further comprises a second snap ring positioned over the second end of the gas exhaust line at the second neck, wherein the second snap ring is configured to compress the gas exhaust line onto the second neck.

Example 16: The liquid sampling device of any one of examples 1-15, wherein the support structure further comprises one or more retainers in the bottom opening configured to retain an adapter.

Example 17: The liquid sampling device of any one of examples 1-16 that further comprises an adapter positioned in the bottom opening of the support structure.

Example 18: The liquid sampling device of example 17, wherein the adapter is comprised of aluminum.

Example 19: The liquid sampling device of any one of examples 1-18, wherein the support structure is comprised of plastic.

Example 20: The liquid sampling device of any one of examples 1-19, wherein the fluid line is comprised of flexible rubber or elastomer.

Example 21: The liquid sampling device of any one of examples 1-20, wherein the fluid line is between 3″ and 36″ in length.

Example 22: The liquid sampling device of example 17, wherein the adapter has a top surface that includes a groove and an O-ring is positioned in the groove to seal between the adapter and an annular wall in the cavity of the support structure.

Example 23: The liquid sampling device of example 16 that comprises a plurality of retainers.

Example 24: The liquid sampling device of example 23 that comprises two retainers.

Example 25: The liquid sampling device of example 24, wherein a first of the two retainers is positioned 180° from a second of the two retainers.

Example 26: The liquid sampling device of example 17, wherein the adapter has a bottom juxtaposed the bottom opening of the support structure and the adapter bottom has a plurality of projections configured to engage a cap on the fluid sample container.

Example 27: The liquid sampling device of example 26, wherein there are four projections.

Example 28: The liquid sampling device of any one of examples 1-27 that further includes the liquid sample container attached to the bottom opening of the support structure.

Example 29: The liquid sampling device of example 17, wherein the adapter further includes an opening therethrough, wherein the opening is configured to permit the passage of liquid and gas therethrough.

Example 30: The liquid sampling device of any one of examples 1-29, wherein the support structure further includes one or more anti-rotation tabs and each of the one or more anti-rotation tabs is received in a respective groove on a bottom surface of the adapter.

Example 31: The liquid sampling device of any one of examples 1-30 that further includes a grounding structure configured to ground a user handling the liquid sampling device or the support structure from static electricity.

Example 32: The liquid sampling device of example 31, wherein the grounding structure comprises (a) a post in the cavity of the support structure, (b) a first wire having a lead connected to the post and a second end connected to a conductive structure configured to be attached to a user, and (c) a second wire having a lead connected to the post and to the lead of the first wire, and a second end configured to be connected to a metallic ground.

Example 33: The liquid sampling device of example 32, wherein the conductive structure configured to be attached to a user is a wrist band.

Example 34: The liquid sampling device of example 32 or example 33, wherein the second end configured to be connected to a metallic ground is a clip.

Some additional non-limiting examples of this disclosure are as follows:

Example 1: A liquid sampling device comprising:
(a) a first connector for connecting to a source of liquid to be sampled;
(b) a fluid line having an outer wall, a lumen inside of the outer wall, a first end attached to the connector and a second end; and
(c) a support structure having a first end, a second end, a cavity, a neck within the cavity, wherein the neck has a first end and a second end, a passage in the neck that extends from the first end to the second end, and opens into a bottom opening of the support, and wherein the bottom opening is configured to attach to a liquid sample container, wherein the first end of the neck is configured to be connected to a snap-fit connector.

Example 2: The liquid sampling device of example 1, wherein the first end of the neck includes internal threads configured to receive external threads of an end of a snap-fit connector.

Example 3: The liquid sampling device of any one of examples 1-2, wherein the snap-fit connector has a first end and a second end connected to the first end of the neck and the first end is positioned outside of the first end of the support structure.

Example 4: The liquid sampling device of example 3, wherein the second end of the snap-fit connector is threaded.

Example 5: The liquid sampling device of any one of examples 1-4, wherein the second end of the fluid line is attached to a snap-fit connector that is configured to be connected to the first end of the snap-fit connector.

Example 6: The liquid sampling device of any one of examples 1-5 that further includes a grounding structure configured to ground a user handling the liquid sampling device or the support structure from static electricity.

Example 7: The liquid sampling device of example 6, wherein the grounding structure comprises (a) a post in the cavity of the support structure, (b) a first wire having a lead connected to the post and a second end connected to a conductive structure configured to be attached to a user, and (c) a second wire having a lead connected to the post and to the lead of the first wire, and a second end configured to be connected to a metallic ground.

Example 8: The liquid sampling device of example 7, wherein the conductive structure configured to be attached to a user is a wrist band.

Example 9: The liquid sampling device of example 7 or example 8, wherein the second end configured to be connected to a metallic ground is a clip.

Some additional non-limiting examples of this disclosure are as follows:

Example 1: A support structure for use with a liquid sampling device, the support structure comprising:
a first end, a second end, an upper cavity, a neck within the upper cavity, wherein the neck has a first end configured to be connected to a liquid fluid line, and a second end, a passage in the neck that extends from the first end to the second end, and wherein the passage opens into a bottom opening of the support structure, and wherein the bottom opening is configured to attach to a liquid sample container.

Example 2: The support structure of claim 1 that further comprises a fluid line having a first end, a second end, and a lumen, wherein the second end of the fluid line is connected to the first end of the neck, and the lumen is in communication with the passage.

Example 3: The support structure of example 1 or example 2, wherein the bottom opening comprises threads configured to mate with threads on the liquid sample container.

Example 4: The support structure of any one of examples 1-4, wherein the support structure comprises a cylindrical outer surface.

Example 5: The support structure of example 4, wherein the cylindrical outer surface comprises a grip section.

Example 6: The support structure of example 5, wherein the support structure comprises a height and the grip section extends along 50% or more of the height.

Example 7: The support structure of example 4, wherein the cylindrical outer surface comprises an annular groove configured to receive an O-ring of a sealing cap.

Example 8: The support structure of example 7 that further includes the sealing cap, and wherein the O-ring is positioned in the annular groove and the sealing cap has a first position in which it is positioned on and seals the bottom opening of the support structure and a second position in which it is removed from the bottom opening of the support structure.

Example 9: The support structure of any one of examples 1-8 that further includes (a) a gas reservoir configured to receive gas exiting the liquid sample container as liquid centers the liquid sample container, and (b) a second neck having a first end, a second end, and a passage extending from the first end to the second end, wherein the passage is in communication with the gas reservoir and is configured to exhaust the gas through the first end of the second week.

Example 10: The support structure of example 9 that further includes a gas exhaust line comprising a first end, a second end, an outer wall, and an exhaust lumen, wherein the second end of the gas exhaust line is connected to the first end of the second neck.

Example 11: The support structure of example 10, wherein the second neck has one or more outer rings configured to retain the gas exhaust line on the second neck.

Example 12: The support structure of any one of examples 1-11, wherein the neck has one or more outer rings configured to be received inside of a lumen of a fluid line and help retain the fluid line on the first neck.

Example 13: The support structure of example 2 that further comprises a first snap ring positioned over the second end of the fluid line at the neck, wherein the first snap ring is configured to compress the fluid line onto the neck.

Example 14: The support structure of example 10 that further comprises a second snap ring positioned over the second end of the gas exhaust line at the second neck, wherein the second snap ring is configured to compress the gas exhaust line onto the second neck.

Example 15: The support structure of any one of examples 1-14, wherein the support structure further comprises one or more retainers in the bottom opening, wherein the one or more retainers are configured to retain an adapter.

Example 16: The support structure of any one of examples 1-15 that further comprises an adapter positioned in the bottom opening of the support structure.

Example 17: The support structure of example 15 that further comprises an adapter positioned in the bottom opening of the support structure and that is retained by the one or more retainers.

Example 18: The support structure of example 16, wherein the adapter is comprised of aluminum.

Example 19: The support structure of any one of examples 1-18, wherein the support structure is comprised of plastic.

Example 20: The support structure of example 2, wherein the fluid line is comprised of flexible rubber or elastomer.

Example 21: The support structure of example 2, wherein the fluid line is between 3″ and 36″ in length.

Example 22: The support structure of example 16, wherein the adapter has a top surface that includes a groove and an O-ring is positioned in the groove to seal between the adapter and an annular wall in the bottom opening of the support structure.

Example 23: The support structure of example 15 that comprises a plurality of retainers.

Example 24: The support structure of example 23 that comprises two retainers.

Example 25: The support structure of example 24, wherein a first of the two retainers is positioned 180° from a second of the two retainers.

Example 26: The support structure of example 16, wherein the adapter has an adapter bottom juxtaposed the second end of the support structure and the adapter bottom has a plurality of projections configured to engage cap projections on a secure cap on the fluid sample container.

Example 27: The support structure of example 26, wherein the adapter has two sets of two projections.

Example 28: The support structure of any one of examples 1-27 that further includes the liquid sample container attached to the bottom opening.

Example 29: The support structure of example 16, wherein the adapter further comprises an adapter opening therethrough, wherein the adapter opening is configured to permit the passage of liquid and gas therethrough.

Example 30: The support structure of any one of examples 1-29 that further comprises one or more anti-rotation structures in the bottom opening and each of the one or more anti-rotation structures is received in a respective opening on a flange of an adapter positioned in the bottom opening.

Example 31: The support structure of example 27, wherein there is a pocket between each set of two projections and the pocket is configured to receive and retain a cap projection on a security cap positioned on the liquid sample container.

Example 32: The support structure of example 31, wherein one projection of each set of two projections has an angled or curved side surface on a side opposite the pocket.

Example 33: The support structure of example 16, wherein the adapter comprises a third O-ring groove configured to receive a third O-ring.

Example 34: The support structure of example 16, wherein the adapter comprises a flange.

Example 35: The support structure of example 34, wherein the flange has one or more openings on its outer edge that are configured to receive an anti-rotation surface positioned in the bottom opening in order to prevent the adapter from rotating.

Example 36: The support structure of any one of examples 1-35, wherein the first end of the neck is configured to be connected to a snap-fit connector.

Example 37: The support structure of example 36, wherein the passage of the first neck includes internal threads configured to receive external threads of an end of a snap-fit connector.

Example 38: The support structure of any of claims 36-37, wherein the snap-fit connector has a first end and a second end connected to the neck and the first end is positioned outside of the first end of the neck.

Example 39: The support structure of example 38 that further includes a fluid line having a first end, a second end, an outer wall, and a lumen and wherein the second end of the fluid line is attached to the first end of the snap-fit connector.

Example 40: The support structure of any one of examples 1-39 that includes an O-ring in a channel in the bottom opening, wherein the O-ring is configured to seal between the bottom opening and the liquid sample container when the liquid sample container is positioned in the bottom opening.

Example 41: The support structure device of any one of examples 1-40 that further includes a grounding structure configured to ground a user handling the liquid sampling device or the support structure from static electricity.

Example 42: The support structure of example 41, wherein the grounding structure comprises (a) a post in the cavity of the support structure, (b) a first wire having a lead connected to the metal post and a second end connected to a conductive structure configured to be attached to a user, and (c) a second wire having a lead connected to the post and to the lead of the first wire, and a second end configured to be connected to a metallic ground.

Example 43: The support structure of example 42, wherein the conductive structure configured to be attached to a user is a wrist band.

Example 44: The support structure of example 42 or example 43, wherein second end configured to be connected to a metallic ground is a clip.

Example 45: An adapter for use in a support structure of a fluid sampling device, wherein the adapter comprises a first end, a second end, a passage extending form the first end to the second end, and one or more projections at the second end, wherein each of the one or more projections is configured to receive a cap projection of a secure cap.

Example 46: The adapter of claim 45 that includes an outward-extending flange having a surface configured to rest against one or more retainers in the support structure in order to position the adapter in a bottom opening of the support structure.

Example 47: The adapter of claim 46, wherein the flange has an outer edge and one or more openings in the outer edge, wherein the openings each of the one or more openings is configured to receive an anti-rotational projection of the support structure in order to prevent the adapter from rotating.

Example 48: The adapter of any one of examples 45-47 that includes a first O-ring groove configured to receive an O-ring that seals between the adapter and a bottom opening of the support structure.

Example 49: The adapter of anyone of examples 45-48 that includes a second O-ring groove configured to retain an O-ring that seals between the adapter and a top of liquid sample container when the liquid sample container is in a bottom opening of the support structure.

Example 50: The adapter of any one of examples 45-49 that has a plurality of projections.

Example 51: The adapter of example 50 that has two sets of two projections, wherein there is a pocket between each set of two projections.

Example 52: The adapter of example 47, wherein one projection of each set of two projections has an angled or curved surface in a side opposite the pocket.

Example 53: The adapter of any one of examples 1-52 that further includes a grounding structure configured to ground a user handling the support structure from static electricity.

Example 54: The support structure of example 53, wherein the grounding structure comprises (a) a post in the cavity of the support structure, (b) a first wire having a lead connected to the post and a second end connected to a conductive structure configured to be attached to a user, and (c) a second wire having a lead connected to the post and to the lead of the first wire, and a second end configured to be connected to a metallic ground.

Example 55: The support structure of example 54, wherein the conductive structure configured to be attached to a user is a wrist band.

Example 56: The support structure of example 54 or example 55, wherein the second end configured to be connected to a metallic ground is a clip.

Having thus described different embodiments of the invention, other variations and embodiments that do not depart from the spirit of the invention will become apparent to those skilled in the art. The scope of the present invention is thus not limited to any particular embodiment, but is instead set forth in the appended claims and the legal equivalents thereof. Unless expressly stated in the written description or claims, the steps of any method recited in the claims may be performed in any order capable of yielding the desired product.

What is claimed is:

1. A support structure for use with a liquid sampling device, the support structure comprising:
a first end, a second end, an upper cavity, a neck within the upper cavity, wherein the neck has a first end configured to be connected to a liquid fluid line, and a second end, a passage in the neck that extends from the first end to the second end, and wherein the passage opens into a bottom opening of the support structure, and wherein the bottom opening is configured to attach to a liquid sample container.

2. The support structure of claim 1 that further comprises a fluid line having a first end, a second end, and a lumen, wherein the second end of the fluid line is connected to the first end of the neck, and the lumen is in communication with the passage.

3. The support structure of claim 1, wherein the bottom opening comprises threads configured to mate with threads on the liquid sample container.

4. The support structure of claim 1, wherein the support structure comprises a cylindrical outer surface.

5. The support structure of claim 4, wherein the cylindrical outer surface comprises a grip section.

6. The support structure of claim 5, wherein the support structure comprises a height and the grip section extends along 50% or more of the height.

7. The support structure of claim 4, wherein the cylindrical outer surface comprises an annular groove configured to receive an O-ring of a sealing cap.

8. The support structure of claim 7 that further includes the sealing cap, and wherein the O-ring is positioned in the annular groove and the sealing cap has a first position in which it is positioned on and seals the bottom opening of the support structure and a second position in which it is removed from the bottom opening of the support structure.

9. The support structure of claim 1 that further includes (a) a gas reservoir configured to receive gas exiting the liquid sample container as liquid centers the liquid sample container, and (b) a second neck having a first end, a second end, and a passage extending from the first end to the second end, wherein the passage is in communication with the gas reservoir and is configured to exhaust the gas through the first end of the second week.

10. The support structure of claim 9 that further includes a gas exhaust line comprising a first end, a second end, an outer wall, and an exhaust lumen, wherein the second end of the gas exhaust line is connected to the first end of the second neck.

11. The support structure of claim 10, wherein the second neck has one or more outer rings configured to retain the gas exhaust line on the second neck.

12. The support structure of claim 1, wherein the neck has one or more outer rings configured to be received inside of a lumen of a fluid line and help retain the fluid line on the first neck.

13. The support structure of claim 2 that further comprises a first snap ring positioned over the second end of the fluid line at the neck, wherein the first snap ring is configured to compress the fluid line onto the neck.

14. The support structure of claim 10 that further comprises a second snap ring positioned over the second end of the gas exhaust line at the second neck, wherein the second snap ring is configured to compress the gas exhaust line onto the second neck.

15. The support structure of claim 1, wherein the support structure further comprises one or more retainers in the bottom opening, wherein the one or more retainers are configured to retain an adapter.

16. The support structure of claim 1 that further comprises an adapter positioned in the bottom opening of the support structure.

17. The support structure of claim 15 that further comprises an adapter positioned in the bottom opening of the support structure and that is retained by the one or more retainers.

18. The support structure of claim 16, wherein the adapter has a top surface that includes a groove and an O-ring is positioned in the groove to seal between the adapter and an annular wall in the bottom opening of the support structure.

19. The support structure of claim 15 that comprises two retainers, and wherein a first of the two retainers is positioned 180° from a second of the two retainers.

20. The support structure of claim 16, wherein the adapter has an adapter bottom juxtaposed the second end of the support structure and the adapter bottom has a plurality of projections configured to engage cap projections on a secure cap on the fluid sample container.
